(19) United States
(12) Patent Application Publication
(10) Pub. No.: US 2025/0164851 A1
(43) Pub. Date: May 22, 2025

(54) TUNABLE ORBITAL ANGULAR MOMENTUM SYSTEM

(71) Applicant: Clemson University, Clemson, SC (US)

(72) Inventors: Eric Johnson, Winter Springs, FL (US); Jerome Keith Miller, Seneca, SC (US); Evan Robertson, Pendleton, SC (US); Tyler Cramer, Summerville, SC (US); Matthew Reid, Clemson, SC (US); Jaxon Wiley, Clemson, SC (US)

(73) Assignee: Clemson University, Clemson, SC (US)

(21) Appl. No.: 18/882,287

(22) Filed: Sep. 11, 2024

Related U.S. Application Data
(63) Continuation-in-part of application No. 18/318,345, filed on May 16, 2023.
Application No. 18/318,345 is a continuation-in-part of application No. 17/838,632, filed on Jun. 13, 2022.
Application No. 17/838,632 is a continuation of application No. 16/725,293, filed on Dec. 23, 2019, now Pat. No. 11,402,722.
(60) Provisional application No. 63/342,865, filed on May 17, 2022.
(60) Provisional application No. 62/784,202, filed on Dec. 21, 2018.

(51) Int. Cl. G02F 1/33; H04B 10/27

(52) U.S. Cl. CPC G02F 1/33; H04B 10/27

(57) ABSTRACT

This system and method of for providing a tunable orbital angular momentum system for providing higher order Bessel beams comprising: an acousto-optical deflector configured to receive an input beam, deflect a first portion of the input beam a first deflection angle relative to an axis of propagation and along an optical axis and deflect a second portion of the input beam a second deflection angle relative to the optical axis; a line generator disposed along the optical angle for receiving the first portion and the second portion of the input beam and provide an elliptical Gaussian mean; a log-polar optics assembly disposed along the optical angle for receiving the elliptical Gaussian beam and wrapping the elliptical Gaussian beam with an asymmetric ring; and, a Fourier lens configured to receive the wrapped elliptical Gaussian beam.

### RELATED APPLICATIONS

This application is a continuation of U.S. patent application Ser. No. 18/318,345 field May 16, 2023 which claims priority from U.S. Provisional Patent Application 63/342,865 filed May 17, 2022 and is a continuation in part of U.S. patent application Ser. No. 17/838,632 which is a continuation of U.S. patent Ser. No. 16/725,293 filed Dec. 23, 2019 which claims priority on U.S. Provisional Patent Application 62/784,202 filed Dec. 21, 2018, all of which are incorporated by reference.

### STATEMENTS REGARDING FEDERALLY SPONSORED RESEARCH

This invention was made with government support under Federal contracts N00014-16-1-3090, N00014-17-1-2779 and N00014-20-1-2558 awarded by the Office of Naval Research through its multidisciplinary university research initiative. The government has certain rights in the invention.

### BACKGROUND OF THE INVENTION

### 1) Field of the Invention

This system is a novel system and technique for exploiting a uniform circular frequency diverse array of optical beamlets to realize non-diffracting beams with unprecedented switching rates in orbital angular momentum.

### 2) Description of the Related Art

In modern computing, communications, data processing and information technologies, the calculations speed, processing times, storage capacity and speed for data retrieval continue to rapidly improve. However, such improvements are limited by physical restrictions such as how fast information can move from one place to another. Transmissions speeds are limited by the number bits of information that can be transmitted using a single photon in a light beam having an orbital angular momentum (OAM) that is not zero. Generally, the number of orthogonal states of the orbital angular momentum of a photon determines the number of bits that can be carried by the photon.

One technique for OAM mode switching uses spatial light modulators (SLM). However, this technique and device has a very limited switching speed resulting in disadvantages over the present system. While digital micro-mirror devices (DMD) can boost switching speeds up to tens of kHz, which is comparable with the switching speed of a direct OAM mode emitter, the DMD micro-mirror pitch limits the spatial resolution and is only acceptable for lower optical power applications. Further, the mode emitter is limited to only tuning integer OAM modes. Fractional OAM modes, also referred to as non-integer, continuous, successive, and rational modes are advantageous but not presently provided with DMD technologies.

It would also be beneficial if there were fractional OAM Bessel beams that could form any number of orthogonal subsets of OAM modes which could be advantageous for optical communications, including in-flight optical security applications. Further, fractional OAM Bessel beams can preserve the non-diffracting properties that integer OAM beams possess. This property is advantageous for beam propagation applications, including propagation through turbulence and turbid environments. In addition, fractional OAM modes generated by a synthesis of Laguerre-Gaussian (LG) modes can have advantageous structural stability on propagation to the far field. Previously, a long coherence length laser source was needed to ensure different OAM modes would interfere properly. However, disadvantages are present with long coherence length laser sources so that there is a need for the optical path length difference to be small between simultaneously generated beams with different OAM.

It is an object of the present system to provide for improvements in technologies including communication from classical to quantum applications, optical manipulation of particles, beam shaping, laser beam machining, microscopy, microlithography, direct energy, filamentation, as well as sensing through turbulence in air and underwater environments.

It is another object of the system to provide for the tunable capabilities of present system to improve optical transmissions in various conditions, including environments that change slowly such as turbulence.

It is an object of the present system to provide for a superposition of driving frequencies that result in multiple OAM modes being generated simultaneously.

It is an object of the present invention to provide for a system to improve communications (e.g. high bandwidths, high data rates, minimal absorption, bandwidth scalability, etc.) and seeks to increase the bandwidth of a communication system along with giving added security and encryption with the OAM charge numbers.

It is an object of the present invention to provide for a system to improve imaging as OAM topological charge numbers can propagate better in turbulent environments (e.g., underwater, turbid environments, etc.), especially when a tunable system can scan through the charge numbers to identify a desirable mode on a time scale faster than the changes in the environmental conditions.

### BRIEF SUMMARY OF THE INVENTION

The above objectives are accomplished by providing an optical beam with fast and continuously-tunable orbital angular momentum and have potential applications in classical and quantum optical communications, sensing, and in the study of beam propagation through turbulence. This tunable orbital angular momentum system can generate optical beams using an AOD that can wrap elliptically-shaped Gaussian beams with linear phase tilt to provide a ring. The system can be used with an optical source that can be continuous wave and/or pulsed. The optical source can be encoded with information in terms of a time signal and can be composed of a single wavelength or multiple wavelengths. The system can transmit single or multiple coherent beams with different OAM topological charge numbers.

This system can include the use of an AOD in conjunction with log-polar transformation optics and provides for fast and continuous tuning of the orbital angular momentum (OAM) topological charge number of the output beams. The system generates beams with integer and fractional topological charge numbers. This system can include an acousto-optic deflector to add a linear phase ramp to an optical beam that can be wrapped into an azimuthal phase. The AOD in conjunction with the log-polar optics assembly results in a system that can be used at high power, with fast and continuous OAM mode tuning.

The system herein can provide for a fast-tunable OAM generation system and method that can utilizes an optical geometric transformation known as the log-polar transform. The acousto-optical deflector (AOD) is a fast modulation device used for stable phase modulation and beam shaping. Bessel beams generated using an AOD array and a cylindrical axisymmetric AOD have been provided using this system. In this system, a novel technique for OAM switching and tuning using an AOD in conjunction with a log-polar coordinate transformation system is provided. In one configuration, the maximum mode switching speed for the experimental setup can be measured on the order of 400 kHz, which is determined by the acoustic velocity of the crystal as well as the beam diameter. For a different AOD and a reduced beam size, this speed can reach tens of MHz with sub-microsecond response time, a distinctive improvement over the prior art.

In one configuration, an RF signal is applied to the AOD to produce a traveling wave in a crystal. The frequency of the acoustic signal corresponds to the angle of the 1^{st} order diffraction relative to the 0^{th} order. The system is designed around this angle to produce specific OAM topological charge numbers. As the frequency of the applied signal is varied, the deflection angle of the 1^{st} order changes accordingly. Each frequency corresponds to a specific deflection angle and therefore, a unique OAM charge number. Since the frequency can be controlled with a continuous range, the generated OAM charge numbers can also be generated in a precise and continuous fashion.

In one configuration, the AOD can support a superposition of acoustic signals, producing multiple output beams with different OAM charge numbers. The different OAM modes leaving the system will then coherently interfere.

An AOD can be used to continuously tune the deflection angle of an output optical beam. Because the AOD has a high damage threshold, and can therefore be used in high power laser systems for beam deflecting and laser pulse generation, the integration of an AOD with log-polar transformation optics provides for high power and directed energy related applications not previously possible in the prior art.

The tunable orbital angular momentum system can include an acousto-optic deflector adapted to receive an input beam deflected along an optical axis when a voltage is applied to the acousto-optic deflector wherein the acousto-optic deflector outputs a first output beam having a first deflection beam and a second deflection beam wherein the first deflection beam is in a tilted phase relative to an axis of propagation; a line generator disposed along the optical axis adapted to receive the first output beam and provide a second output beam having an elliptical beam; and, a log-polar optics assembly disposed along the optical axis adapted to receive the second output beam and adapted to transform the second output beam into a third output beam having an asymmetric annular-distribution and to provide a fourth output linear phase wrapped into an asymmetric ring with azimuthal orbital angular momentum phase.

The input beam can include a flat wavefront. The log-polar optics assembly can be adapted to provide an elliptical Gaussian beam having an azimuthal orbital angular momentum phase. The second output beam can be an elliptical beam with an elongated length, a suppressed height and a phase tilt along a horizontal direction specific to an applied acoustic frequency. A Fourier lens can be included and adapted to receive the fourth output prior to the fourth output being provided. The log-polar optics assembly can include a first log-polar optic and a second log-polar optic cooperatively associated to map the second output beam to an asymmetric ring profile. The first log-polar optic and the second log-polar optic can be cooperatively associated to map the second output beam to a phase-corrector adapted to correct a phase distortion introduced by a wrapper. The input beam can be a Gaussian input.

The system can include a deflection angle defined by the first deflection beam and the second deflection beam that is continuously tunable by adjusting a frequency of an acoustic signal of the acousto-optic deflector. The system can include a first 4-f line generator adapted to image the first deflection beam into a line shape beam's linear phase and a second 4-f line generator adapted to elongate a circular input beam into the input beam. The line generator can be adapted to shape the first deflection beam and the second deflection beam of the input beam into an elliptical Gaussian beam using a first lens and a second lens. The acousto-optical deflector can be adapted to add a linear phase gradient to the input beam. The line generator can be adapted to elongate the first deflection beam and the second deflection beam of the input beam into an elliptical Gaussian line.

The fourth output can be an optical beam carrying digital data. The fourth output can be a wrapped elliptical Gaussian beam adapted for secure digital communication. The fourth output can be a wrapped elliptical Gaussian beam adapted to manage spatial coherence of beams for structured light imaging. The acousto-optic deflector can include a crystal adapted as a Q-switch modulators in a solid-state laser.

The log-polar optics assembly can be disposed along the optical axis and adapted to receive the second output beam and adapted to transform the second output beam into a third output beam having an asymmetric annular-distribution to provide a fourth output linear phase wrapped into an asymmetric ring with azimuthal orbital angular momentum phase wherein the fourth output includes multiple modes. The multiple modes can be provided by applying a superposition of multiple RF frequencies. The multiple modes can include factional modes.

This system can alco include a log-polar optics assembly adapted to receive an input beam having an orbital angular momentum and provide a first output beam; an acousto-optic deflector adapted to receive the first output beam and scan through a frequency range and detect charge numbers associated with the input beam; and, a fiber coupled detector adapted for receiving the first output beam and determining the orbital angular momentum modes. The system can include a first telescope adapted to receive the input beam prior to the input beam being received by the log-polar optics assembly and a second telescope adapted to receive an output beam from the log-polar optics assembly and project the output beam to the acousto-optic deflector.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of aspects of the system;

FIG. 2 is a diagram of aspects of the system;

FIG. 3 is a diagram of aspects of the system;

FIG. 4 is an illustration of aspects and results of the system;

FIG. 5 shows illustrations of aspects and results of the system;

FIG. 6 is a schematic of aspects of the system;

FIG. 7 is a schematic of aspects of the system;

FIG. 8 is an illustration of aspects and results of the system;

FIG. 9 is an illustration of aspects and results of the system;

FIG. 10 is an illustration of aspects and results of the system;

FIG. 11 is an illustration of aspects and results of the system;

FIG. 12 is an illustration of aspects and results of the system;

FIG. 13 is an illustration of aspects and results of the system;

FIGS. 14A and 14B are illustrations of aspects and results of the system;

FIGS. 15A and 15B are illustrations of aspects and results of the system;

FIG. 16 is an illustration of aspects and results of the system;

FIG. 17A is an illustration of aspects and results of the system;

FIG. 17B is an illustration of aspects and results of the system;

FIG. 18A is an illustration of aspects and results of the system;

FIG. 18B is an illustration of aspects and results of the system;

FIG. 19A is an illustration of aspects and results of the system;

FIG. 19B is an illustration of aspects and results of the system;

FIG. 20 is an illustration of aspects of the system;

FIG. 21A is an illustration of aspects and results of the system;

FIG. 21B is an illustration of aspects and results of the system;

FIG. 22A is an illustration of aspects and results of the system;

FIG. 22B is an illustration of aspects and results of the system;

FIG. 22C is an illustration of aspects and results of the system;

FIG. 22D is an illustration of aspects and results of the system;

FIG. 23A is an illustration of aspects and results of the system;

FIG. 23B is an illustration of aspects and results of the system;

FIG. 23C is an illustration of aspects and results of the system; and,

FIG. 24 is an illustration of aspects and results of the system.

### DETAILED DESCRIPTION OF THE INVENTION

To improve speeds of information transmission and communications, this system has the capability of switching or hopping between OAM modes and can significantly increase data transmissions rates. Such technical improvements in computer functionality can provide for increased efficiency in computer systems and information systems as a whole. Further, when using the OAM beams provided for by the present invention, switching between different OAM modes can provide for different propagation performances through turbulence environment thereby improving transition rates. The fast switching between OAM modes can provide for the ability to investigate a wide range of OAM modes. Further, sensing applications can benefit from rapidly tunable OAM that includes beam steering through a scattering media, particle manipulation using three dimensional beams, object rotation detection, temperature sensing, and motion detection. Therefore, transmission of data can be improved and customized to the environment dynamically.

This system can include novel higher order Bessel beams integrated in time architecture for the rapid generation and time variation of non-diffracting beams with engineered light frequencies. In one embodiment, this system can use architecture that relies on the use of an acousto-optic deflector to uniquely frequency shift each generated beamlet which gives rise to frequency diversity. Due to the time-dependent phase accumulation across the frequency diversity array, orbital angular momentum (OAM) states are scanned at a rate of 20 ns per integer OAM with a maximum OAM of m=±64 for the standard Bessel-Gaussian modes with a 128 beamlet array. This generation architecture has additional control of the initial phase and amplitude of each individual beamlet in the array. Using this control, the non-diffracting amplitude structures were customized while still having the rapid time evolution afforded by the frequency diversity. The non-diffracting nature of the generated beams was demonstrated with minimal change in the beam structure over the range of 12 Rayleigh lengths. The results presented are using a pulsed source to visualize the individual modes. However, this uniform circular frequency diverse array (UC-FDA) technique is ideally suited for a continuous wave (CW) source, as demonstrated in the radio frequency (RF) regime highlighted in the introduction, to take advantage of the rapid, continual mode scanning for imaging, ranging, and communications applications. These applications are currently being explored using a continual mode scanning CW system. Furthermore, the system is robust and simple, with no need for mechanical components or active control and can easily be applied to sensing dynamic environments, microscopy, or machining. Additionally, the output from the UC-FDA system can be used as a seed for a power amplifier to address the efficiency using a large number of beamlets. The system can include aberration correction for the lateral shift on the log-polar optics for higher charge numbers, and wavelet formulation exploiting the properties of the frequency diverse array to improve the system efficiency over the prior art.

In one embodiment, this system uses a uniform circular frequency diverse array (UC-FDA) of optical beamlets to realize non-diffracting beams with unprecedented switching rates in orbital angular momentum (OAM). The frequency diversity property of the system is a result of using an acousto-optic deflector (AOD) to generate an array on a circle which tags each beamlet with different frequencies. The non-diffracting nature of the generated beams is examined along with the generation of arbitrary time-dependent non-diffracting amplitude structures using the local phase control inherent in the system architecture. The resulting system can dynamically change the OAM at a rate of 20 ns per integer with maximum range of m=±64 over 2.56 μs.

The growing interest in properties, including angular and polarized properties, of optical beams as new applications are being addressed by the system described herein. The ability to quickly switch between OAM modes is advantageous to this effort and for new applications of this technology. Further, this system provides improvements in structured light progress by using advancements in the control of the various degrees of freedom associated with frequency, polarization, and spatial modes leveraging orbital angular momentum as an example. This system can expand these controls and can provide improvements to the existing technologies in optical sensing, communications, and imaging. This system overcomes the traditional problem of not being able to leverage the temporal control due to the lack of switching speed for many architectures in the optical regime. This system can also use frequency diversity in the RF spectrum to leverage and improve the technology for the generation of time-varying OAM beams. Unlike the prior art, this system has the ability to use uniform circular frequency diverse array architecture and apply it to the optical domain.

This system can be included in a family of structured light modes that are garnering particular interest in that it has non-diffracting modes, which maintain their structure longer than an equivalently sized Gaussian beam. These can be used to improve optical machining, imaging, sensing and trapping. Specifically, these non-diffracting properties can be used to improve thermal gradients and surface finishing in additive manufacturing, enhancing ghost imaging in turbulent environments, and extending the depth of focus in microscopy. These modes can be characterized by having a single spatial frequency component, similar to Bessel beams, whose Fourier transform is a delta ring, or perfect vortex beam. Furthermore, in one embodiment, the system can use higher order Bessel beams (HOBBS) to retain the non-diffracting property as the azimuthal phase does not affect the spatial frequency. These improvements can lead to several demonstrations of non-diffracting beams with arbitrary amplitude distributions.

This system can include techniques for the rapid realization of structured modes. Spatial light modulators (SLMs) and digital micromirror devices (DMDs) can be used for structured light generation with switching rates at 10's of Hz and 10's of kHz, respectively. In one embodiment, a system resolved the rate limitation of the SLMs and provided for a system for producing higher order Bessel beams integrated in time (HOBBIT) that employed an AOD to generate spatial tilts. Each tilt can be mapped to an OAM through the log-polar mapping, capable of tuning OAM values at 400 kHz with a typical OAM range of ±10. To enhance the resolution and control required for probing complex environments, an optical wavelet was used, allowing for simultaneous OAM control and azimuthal windowing. One embodiment includes a windowed Fourier transform approach, using two AODs, where a frequency-tagged single beamlet was generated for probing and propagation through turbulence. In one embodiment, an AOD was used to generate multiple frequency-tagged beamlets with a second AOD encoding OAM onto the beam for probing rotational objects exploiting Frequency Diversity for sensing.

The system can expand on these embodiments for scanning individual frequency-tagged beamlets and can generation of an array of frequency-tagged beamlets using an AOD in the Bragg condition with multiple frequencies. The resulting beamlet array can be mapped to a perfect vortex (PV) using a log-polar coordinate transform. This serves as the UC-FDA providing a time-varying system that linearly scans the OAM modes at a rate proportional to the difference in frequencies in the array. This UC-FDA can be propagated to the far-field, creating a range of diffraction free optical beam structures depending on the amplitude and phase of the beamlets. This system can use an acousto-optic deflector (AOD) combined with basic coordinate transform optics to provide a fundamental understanding behind the concept and the various degrees of freedom for the generation of higher order Bessel beams (HOBBS) with rapid temporal control induced by the frequency diversity, termed Engineered Light Frequencies (ELFs). The system provides results presented for HOBBITs using frequency diversity to show the spatial and temporal control. Further, results are provided herein for more complex non-diffracting beams using amplitude and phase control combined with the frequency diversity.

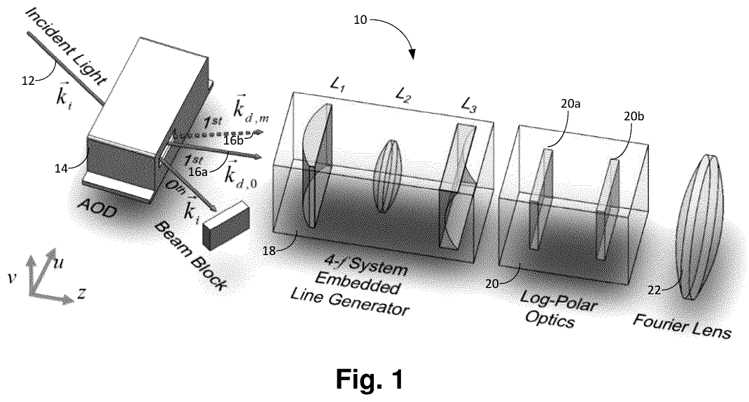

With reference to the drawings, the invention will now be described in more detail. Referring to FIG. 1, an optical configuration 10 used to generate OAM modes is shown. In this technique, an input beam 12, Gaussian or otherwise, is passed through an acousto-optic deflector (“AOD”) 14. When a voltage signal with the central frequency of the AOD is applied, the 1^{st} order deflection of the Gaussian input is at the Bragg condition with the Gaussian beam propagating along the optical axis. In this orientation, the Gaussian beam can have a flat wavefront, and the designed system will generate an OAM mode of charge equal to zero, 16A. When the frequency of the acoustic wave deviates from this center frequency, the beam is instead deflected by some additional angle16B along the horizontal direction. The deviation away from the Bragg condition results in the 1^{st} order deflection with a tilted phase relative to the axis of propagation. The output of the AOD is then passed through a line generator 18, used as a dual-axis manipulator. The output of the line generator can include an elliptical beam with an elongated length and a suppressed height with a phase tilt along the horizontal direction specific to the applied acoustic frequency. The line generator can be an f-type in one embodiment. This elliptical beam then propagates through log-polar optics assembly 20 that wrap the ellipse into an asymmetric annular-distribution. The beam can then pass through a Fourier lens 22. Overall, this results in an elliptical Gaussian beam with linear phase being wrapped into an asymmetric ring with azimuthal OAM phase.

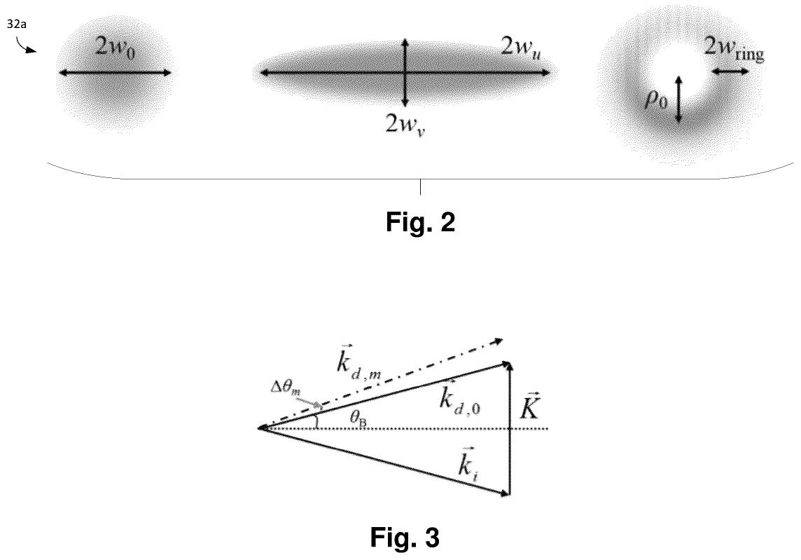

Referring to FIG. 2, the input into the AOD can have a Gaussian distribution with the diameter of the beam defined as 2_{w}_{₀} as shown by 32a. The momentum vector of incident photon can be \vec{kₗ}, that of the diffracted photon can be \vec{k_{d}}, and that of the photon can be \vec{K}. According to the principle of momentum conservation, the momentum vector of the diffracted photon should be equal to the sum of the momentum vectors of the incident photon and of the acoustic phonon \vec{k_{d}}=\vec{kₗ}+\vec{K}, as shown in FIG. 3. The notation \vec{k_{d,0}} and \vec{k_{d,m}} is used for the diffracted photon's momentum vector when the far-field beam has charge 0 and m, respectively. The OAM mode index m=l+α is a continuous charge number in which I is the integer part and α is the fractional part, which is defined as a positive real number 0≤α<1. The Bragg angle in FIG. 1 can be represented as

$${θ}_{B} ≅ sin {θ}_{B} = \frac{\vert \vec{K} \vert}{2 \vert {\vec{k}}_{l} \vert} = \frac{{λ}_{0} {f}_{0}}{2 {V}_{a}} , \qquad ( 1 )$$

where λ₀ is the electromagnetic wave Doppler shifted wavelengths corresponding to the OAM charge 0, V_{α} is the acoustic velocity and f₀ is the driving frequency of the AOD that results in the Bragg condition, and can also be the frequency corresponding with charge 0 output. The 1^{st} order diffractive angle can be 2θ_{B}. By deviating the applied frequency away from the Bragg condition, Δfₘ=|f₀−fₘ|, where fₘ is the AOD driving frequencies corresponding with charge m output, there is a change in the deflection angle of the beam for charge m as

$$Δ {θ}_{m} = \vert {θ}_{m} - {θ}_{0} \vert = \vert \frac{{λ}_{m} \cdot {f}_{m}}{{V}_{a}} - \frac{{λ}_{0} \cdot {f}_{0}}{{V}_{a}} \vert \approx \frac{{λ}_{m} \cdot \vert {f}_{m} - {f}_{0} \vert}{{V}_{a}} = \frac{{λ}_{m} \cdot Δ {f}_{m}}{{V}_{a}} , \qquad ( 2 )$$

where λₘ is the electromagnetic wave Doppler shifted wavelengths corresponding to the OAM charge m. Since these wavelengths are extremely close with each other, differing by femtometers for a 532 nm input signal, we can assume λₘ≈λ₀. The angle deviation after the line generator, Δθ′ₘ, will be scaled by the magnification of the 1^{st} 4-f system according to

$$Δ {θ}_{m}^{′} = Δ {θ}_{m} \frac{{F}_{1}}{{F}_{2}} , \qquad ( 3 )$$

where F₁ and F₂ are the focal lengths of the lenses L₁ and FL₁, respectively, in FIG. 1. According to the paraxial approximation, this angle deviation corresponds to charge m and can be represented by

$$Δ {θ}_{m}^{′} \approx tan ( Δ {θ}_{m}^{′} ) = \frac{{λ}_{m} m}{2 π a} , \qquad ( 4 )$$

where α is the log-polar optics design parameter that scales the transformed line length in the unwrapping procedure. Combining Eq. (2)-(4) results in an expression for charge m as a function of the frequency change from the Bragg condition given by

$$m = \frac{2 π a ( Δ {f}_{m} ) {F}_{1}}{{V}_{a} {F}_{2}} . \qquad ( 5 )$$

As shown in FIG. 1, the 1^{st} order deflected beam exiting the AOD is a Gaussian distribution, which can be expressed as

$$\begin{matrix}{U}_{AOD \_l st} ( u , v ) = exp [ - \frac{( {u}^{2} + {v}^{2} )}{{w}_{0}^{2}} ] exp [ i ( 2 π ( {f}_{c} + {f}_{m} ) t - {\vec{k}}_{d , m} \cdot \vec{r} ) ] \\ = exp [ - \frac{( {u}^{2} + {v}^{2} )}{{w}_{0}^{2}} ] exp [ i ( 2 π ( {f}_{c} + {f}_{m} ) t - {k}_{z} z - {k}_{u} u ) ] .\end{matrix} \qquad ( 6 )$$

where u and v are both Cartesian coordinates, f_{c} is the input laser's central frequency, k_{z}=2πcos (Δθₘ)/λₘ and

$${k}_{u} = 2 π sin \frac{Δ {θ}_{m}}{{λ}_{m}} \approx \frac{2 π Δ {θ}_{m}}{{λ}_{m}}$$

are the wavenumbers along the z and u direction, and finally (f_{c}+fₘ) and λₘ are the electromagnetic wave Doppler shifted frequency and wavelength corresponding to the OAM charge m. After passing through the AOD 14 (FIG. 1), the beam is sent to the line generator to be shaped into an elliptical Gaussian distribution using lenses L₁, L₂ and L₃ with focal lengths F₁, F₂ and F₃, respectively. The elliptical Gaussian beam now has diameters in both dimensions, defined as

$$2 {w}_{v} = \frac{2 {w}_{o} {F}_{3}}{{F}_{2}} and 2 {w}_{u} = \frac{2 {w}_{0} {F}_{2}}{{F}_{1}} .$$

The elliptical beam can be expressed as

$${U}_{l i n e} ( u , v ) = exp [ - ( \frac{{u}^{2}}{{w}_{u}^{2}} + \frac{{v}^{2}}{{w}_{v}^{2}} ) ] exp [ i ( 2 π ( {f}_{c} + {f}_{m} ) t - {k}_{z}^{′} z - {k}_{u}^{′} u ) ] , \qquad ( 7 )$$

where the wavenumber along z direction is k′_{z}=2π cos (Δθ′ₘ)/λₘ=2π cos (ΔθₘF₁/F₂)/λₘ, and the wavenumber along u direction is k′ᵤ=2πΔθ′ₘ/λₘ=m/α.

The elliptical Gaussian beam is then incident on the log-polar optics. The system uses a mapping process that uses two log-polar optics: the wrapper that maps the elliptical Gaussian beam to an asymmetric ring profile, and the phase-corrector that corrects the phase distortion introduced by the wrapper. Since the elliptical line has a horizontal Gaussian distribution, the system wraps it into an asymmetric ring with a ring radius, β₀, defined from the origin to peak intensity location and width, 2w_{ring}, as shown in FIG. 3. Given the log-polar mapping equation of u=α arctan (y/x)=αϕ, the near-field output from the system is given by

$${U}_{n e a r} ( ρ , ϕ ) = exp [ - ( \frac{{( ρ - {ρ}_{0} )}^{2}}{{w}_{ring}^{2}} + \frac{{ϕ}^{2}}{{( β π )}^{2}} ) ] exp [ i ( - m ϕ + 2 π ( {f}_{c} + {f}_{m} ) t - {k}_{z}^{′} z ) ] , \qquad ( 8 )$$

where ρ and ϕ are both the radial and azimuthal polar coordinates in the near-field plane, ρ₀=b exp (−v₀/α) is the wrapped ring's radius defined from the origin to peak intensity location,

$${w}_{r i n g} = {ρ}_{0} sinh ( \frac{{w}_{v}}{a} )$$

is the wrapped ring's half width v₀, is the input elliptical Gaussian beam's offset from the center of the wrapper, wᵥ=w₀F₃/F₂ is the half width of the input elliptical Gaussian beam, α is the log-polar optics design parameter which scales the transformed line length in unwrapping procedure, b is another log-polar optics design parameter which scales the transformed ring size in the wrapping procedure, and β=w₀F₂/(παF₁) is the ratio of input elliptical Gaussian line's length to the designed input line length 2πα. The Fourier transform of Eq. (8) can then be derived as

$${U}_{far} ( r , θ ) = A exp ( - \frac{{r}^{2}}{{w}_{G}^{2}} ) exp [ i ( 2 π ( {f}_{c} + {f}_{m} ) t - {k}_{z}^{′} z ) ] {\sum }_{n = - ∞}^{∞} {B}_{n} exp ( i n θ ) {J}_{n} ( \frac{2 π {ρ}_{0}}{{λ}_{m} F} r ) , \qquad ( 9 )$$

where r and θ are the radial and azimuthal polar coordinates in the far field plane, A=w_{ring}²βπ^{5/2} β₀/(2λ₀F), w_{G}=λₘF/(πw_{ring}), F is the focal length of the Fourier lens,

$${B}_{n} = {( - i )}^{n - 1} 2 exp [ - {β}^{2} {{π}^{2} ( 1 + α - n )}^{2} / 4 ] Im ( erfi \frac{i}{β} + \frac{β π ( 1 + α - n )}{2} ) , erfi ( x ) = \frac{erf ( i x )}{i}$$

is the imaginary error function, and finally lm(z) gives the imaginary part of complex number z. The far-field of the ring-shaped beam in Eq. (9) is the combination of a group of Bessel-Gaussian (BG) beams carrying OAM. It can be a weighted linear combination of integer OAM phase carrying n^{th}-order Bessel function of the 1^{st} kind modulated by the same Gaussian envelope. The parameter βₙ is the weighting or selection factor, which distributes the power within the central 2 to 3 modes and decays rapidly as m approaches positive and negative infinity. When α=0, then m=l, meaning an integer charge will be select as n=l, and Bₗ is the maximum value. As α increases, the central weighting factor Bₙ's maximum value will move from n=l to n=l+1. This means fractional-charged OAM-carrying BG beams are a linear combination of integer BG beams. Considering the α=0 case, the Bₙ parameter has the property of

$${B}_{m - k} = {( - 1 )}^{k} {B}_{m + k} , k = 0 , 1 , 2 , \qquad ( 10 )$$

The far-field complex amplitude described by Eq. (9) can be rewritten as

$${U}_{far} ( r , θ ) = A exp ( - \frac{{r}^{2}}{{w}_{G}^{2}} ) exp [ i ( m θ + 2 π ( {f}_{m} + {f}_{c} ) t - {k}_{z}^{′} z ) ] \cdot \qquad ( 11 )$$

$$\{ \begin{matrix}{B}_{m} {J}_{m} ( \frac{2 π {ρ}_{0} r}{{λ}_{m} F} ) \\ + i sin θ \frac{m {λ}_{m} F}{π {ρ}_{0} r} {B}_{m + 1} {J}_{m} ( \frac{2 π {ρ}_{0} r}{{λ}_{m} F} ) \\ + cos θ {B}_{m + 1} [ {J}_{m + 1} ( \frac{2 π {ρ}_{0} r}{{λ}_{m} F} ) - {J}_{m - 1} ( \frac{2 π {ρ}_{0} r}{{λ}_{m} F} ) ] \\ + {\sum }_{k = 1}^{∞} \{ \begin{matrix}{B}_{m + 2 k + 1} \{ \begin{matrix}cos ( ( 2 k + 1 ) θ [ {J}_{m + 2 k + 1} ( \frac{2 π {ρ}_{0} r}{{λ}_{m} F} ) - {J}_{m - 2 k - 1} ( \frac{2 π {ρ}_{0} r}{{λ}_{m} F} ) ] \\ + i sin ( ( 2 k + 1 ) θ ) [ {J}_{m + 2 k + 1} ( \frac{2 π {ρ}_{0} r}{{λ}_{m} F} ) + {J}_{m - 2 k - 1} ( \frac{2 π {ρ}_{0} r}{{λ}_{m} F} ) ]\end{matrix} \} \\ + {B}_{m + 2 k} \{ \begin{matrix}cos ( ( 2 k θ ) [ {J}_{m + 2 k} ( \frac{2 π {ρ}_{0} r}{{λ}_{m} F} ) + {J}_{m - 2 k} ( \frac{2 π {ρ}_{0} r}{{λ}_{m} F} ) ] \\ + i sin ( ( 2 k θ ) [ {J}_{m + 2 k} ( \frac{2 π {ρ}_{0} r}{{λ}_{m} F} ) - {J}_{m - 2 k} ( \frac{2 π {ρ}_{0} r}{{λ}_{m} F} ) ]\end{matrix} \}\end{matrix} \}\end{matrix} \} \cdot$$

This indicates that these beams are comprised of only one integer OAM phase exp (imθ), and the Bessel term of BₘJₘ(2πρ₀r/λₘF) dominates, since Bₘ is the maximum of Bₙ. The standing wave terms sin θ·mλₘFBₘ₊₁Jₘ(2πβ₀r/λₘF)/πβ₀r and cos θ·Bₘ₊₁[Jₘ₊₁(2πρ₀r/λₘF)−Jₘ₋₁(2πρ₀r/λₘF)] contribute to the asymmetric intensity of this group of BG beams. In fact, the rest of the Bₙ factors are really small in comparison with the central term and contribute minimally to the BG beam, but still in the form of standing waves.

As can be seen in Eq. (11), a change in β only affects the weighting factor Bₙ. Conceptually, when β is very small, very little power will be contained at the edges of the active zone on the log polar elements. When this whole area is wrapped, there will be a highly asymmetric ring. As β approaches 1, the distribution about the wrapped ring becomes more azimuthally Gaussian. In fact, as β increases beyond 1, the distribution about the wrapped ring becomes more azimuthally uniform and the weighting factors B_{l±1} decrease, but more of the power will be clipped by the log-polar optic aperture. This results in a lower power efficiency of the system but higher modal symmetry. Eq. (9) not only describes the distribution of integer charge numbers, but also fractional charge numbers.

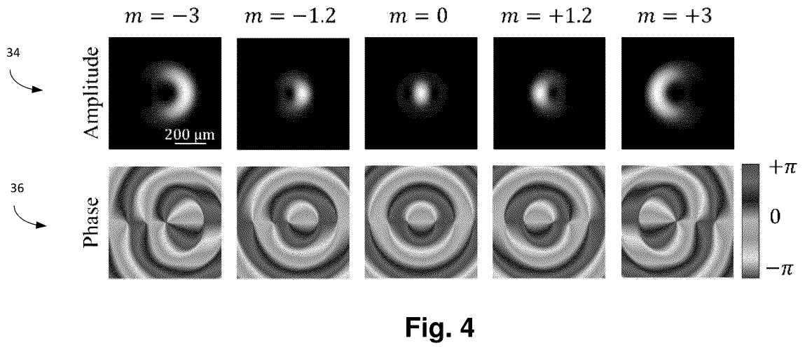

Referring to FIG. 4, analytic intensity and phase profiles using simulation parameters λ=532 nm, β=0.66, w_{ring}=329 μm, ρ₀=850 μm, using 5 central terms, and for the focal length of Fourier lens F=400 mm is shown. Amplitude is shown as 34 with phase shown as 36. Traditionally, the log-polar coordinate transform theory assumes that the input is a rectangular shaped beam. This input results in a reduced translation efficiency due to the fact that a Fourier transform of a rectangular function contains high spatial frequency components. Further, a Gaussian shape produces a Gaussian distribution. In the present system, however, an elliptical Gaussian beam can be generated from a Gaussian input resulting in a higher power efficiency compared to that of a rectangular beam input traditionally used.

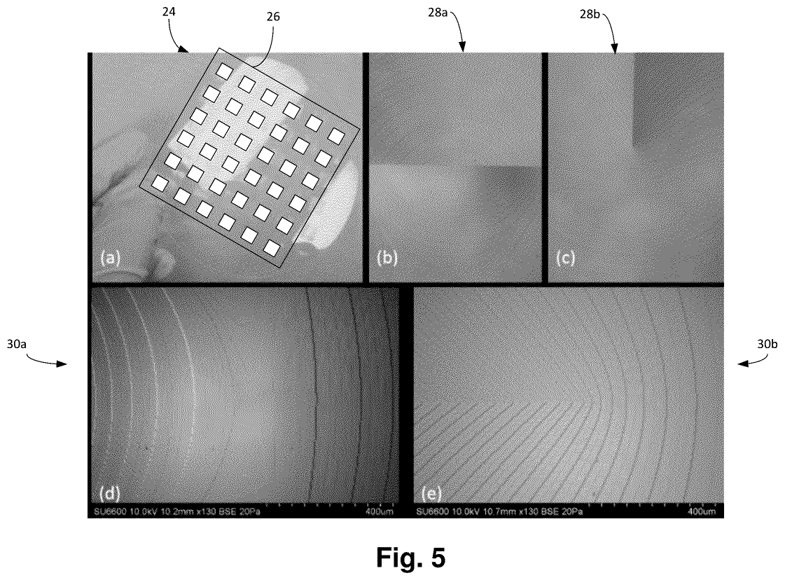

In order to produce the log-polar optics assembly 20 (FIG. 1), the diffractive elements 20a and 20b can be fabricated using a photolithographic method. Referring to FIG. 5, one configuration can be made by fabricating a 6 row×6 column device 24 on a single wafer 26. In one configuration, the optics can be optimized for the wavelength of 532 nm, and have a pixel size of 2 μm×2 μm and 2⁴=16 phase levels. The design parameter a can be 1.8/T mm and b can be 2 mm. The microscope profiles of a wrapper and phase-corrector are shown as 28a and 28b. Scanning-electron microscopy (SEM) images of the fabricated optics are shown as 30a and 30b with magnification of 130 times. The diffraction efficiency of a 4-layer lithographic process diffractive phase element can be about 98%. A 99.9% transmission anti-reflection (AR) coating can be applied on each surface of the log-polar optics that can result in the mean transmission efficiency of both the wrapper and phase corrector combined of about 91% with 0.5% standard deviation from charge −10 to 10.

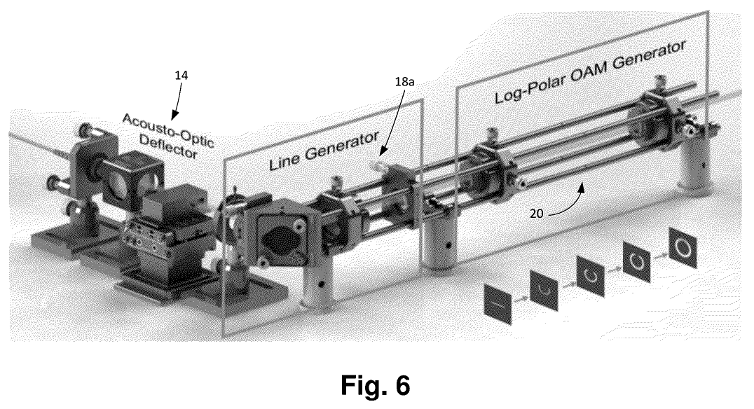

In one embodiment, the AOD that can couple up to 70% of the optical energy into its 1^{st} diffraction order. This deflection angle is continuously tunable by adjusting the frequency of the acoustic signal. The system can apply a 4-f system to image the AOD output deflection angle into the line shape beam's linear phase and another 4-f system to elongate the circular Gaussian beam into an elliptical Gaussian beam. The elliptical Gaussian beam can be incident upon the wrapper and then can be mapped into an azimuthally asymmetric ring-shaped beam during propagation to the phase corrector. After phase correction at the second optical element, the ring-shaped beam carrying OAM phase will form a BG beam in the far-field. One configuration is shown in FIG. 6. The AOD 14 is shown receiving incident light which is then transmitted to a line generator, such as the 4-f line generator 18a in this configuration and on to the log-polar optics 20.

In one configuration, the deflected beam can be generated using a Gooch & Housego AODF 4120-3. This AOD is constructed using a tellurium dioxide (TeO₂) crystal, with a Bragg angle of 2.9°, computed by Eq. (1), as shown in FIG. 7. Input 36 having two deflections, passes through the line generator 18 and log polar optics 20 to produce an output beam 38.

In this configuration, the acoustic velocity is

$$0.65 \frac{mm}{μ s} ,$$

which can be typical for the shear mode of a TeO₂ crystal. An input beam with a diameter of approximately 1.5 mm can be deflected at a rate of approximately 434.8 kHz, corresponding to a measured switching speed of 2.3 μs. Higher switching speeds can be achievable by using other materials such as quartz and fused silica. The acoustic velocity of such devices can be an order of magnitude above the shear-mode TeO₂ devices. By decreasing the beam size through a crystal and with a faster acoustic velocity, switching speeds could be further increased into the tens of megahertz. The transmission efficiency of each surface of the 3 optics in the line generator can be 99%, and the total transmission efficiency of log-polar optics assembly can be 91%. In one configuration, the 1^{st} order diffractive efficiency (DE) of the AOD can be 70% so that the total system efficiency is about 60%. Using a 30 mW input power, the output BG beam is about 18 mW.

In one configuration, the focal lengths L₁ and L₂ are F₁=50 mm and F₂=100 mm respectively, parameter

$$a = \frac{1.8}{π} mm ,$$

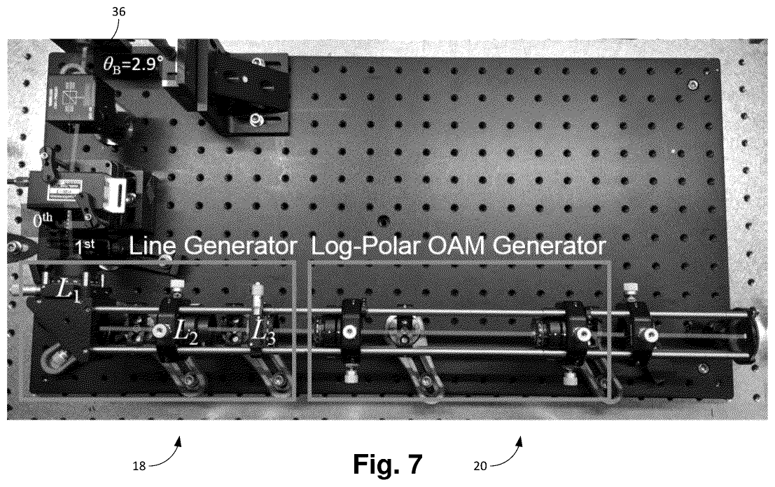

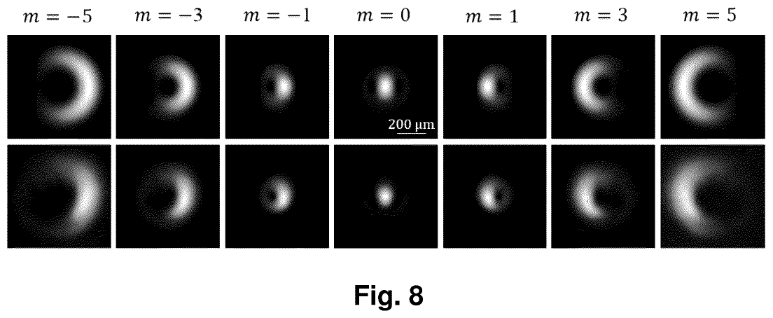

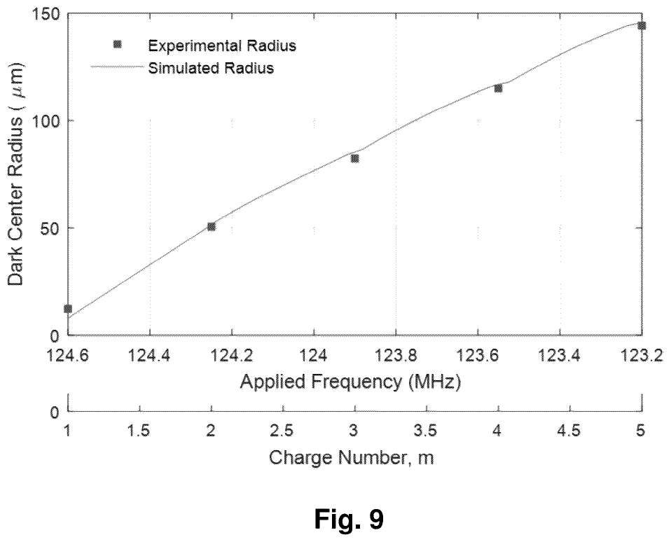

and the frequency index corresponding to Δm=1 interval is Δf₁=0.36 MHz. A series of rings with different OAM phases are output from the log-polar optics assembly. The far-field of this group of ring shape OAM phase carrying beams are BG beams. The generated BG beams are shown in FIG. 8. Referring to FIG. 9, a comparison of the radius of the dark vortex to the corresponding charge numbers as well as driving signal frequencies is shown for both the experimental and simulated beam profiles. This radius was measured by finding the inner radial location of the half-maximum amplitude. The DE of the m=−5 beam is 8.8% lower than the DE of the m=5 beam because the deviation away from the Bragg condition that has the highest DE. The simulated and experiment results of BG beams central dark area's radius vary with charge number as well as AOD driving signal's frequency.

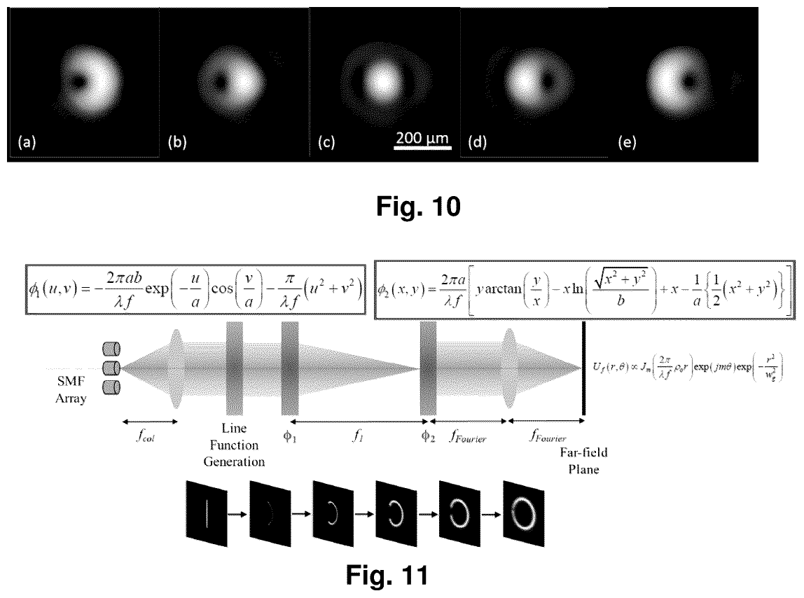

The deflection angle of the 1^{st} order AOD output is continuously tunable as well as the OAM phase. A sample of fractional OAM modes spanning from charge −1.2 to +1.2 in steps of 0.6 is shown in FIG. 10. Referring to FIG. 10, generated fractional OAM BG beams as shown as (a) charge −1.2, (b) charge −0.6, (c) charge 0, (d) charge 0.6, and (e) charge 1.2.

This system and method provide for cascading an AOD with log-polar optics assembly providing for transformation of an optical system to rapidly and continuously tune the output OAM mode of a BG beam. This system has the capability of generating tunable fractional OAM modes. The OAM mode can be controlled through the AOD driving frequency, which can control the amount of linear tilt to be wrapped into a ring through the log-polar transformation.

In one configuration, charge number scans can be defined by an arbitrary waveform across the acousto-optic deflector. The acousto-optic deflector can also be high efficiency and can be configured to withstand high powers with modulation rates 20× over LC spatial light modulators.

The scalar form of the far-field system described herein results in a group of asymmetric fractional BG beams. This system provides for a fast and continuous OAM carrying BG beam tuning solution.

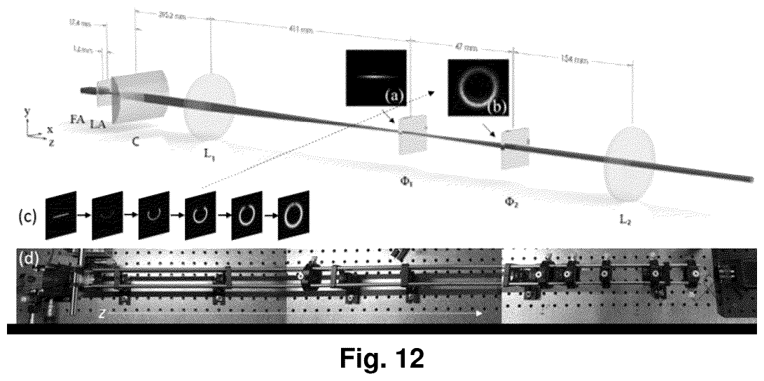

Referring to FIG. 11, one configuration is shown for spatial multiplexing using the system described herein. The charge number can be related to the fiber input port on the input plane as shown in FIG. 12. Further, OAMs can be created from any two input port locations. The charge number can be fixed by fiber spacing on the input array and focal length of the lens in the present design.

Referring to FIG. 13, results for the present system with a 1550 nm spectrum with simulated results shown as (a) channel 1, m=2.0; (b) channel 2, m=0.7; (c) channel 3, m=−0.7; and (d) channel 4, m=−2.0 and the corresponding results shown as (e) to (h). The system herein also provides for a linear phase tilt (which can be the same as shifting the point source above and below the optic axis). A phase tilt can be introduced at the input plane to the system.

Referring to FIG. 14A, shows a single charge number continuous scanning +5 to −5. A coherent combination of conjugate pairs continuous scanning +/−5 to 0 is shown in FIG. 14B. The benefits of the current system can include that OAM can be used for underwater communications and the implementation of coherent multiplexing between OAM states has many applications in maritime sensing. The coherent coupling of OAM modes provides for a modulation scheme that can exploit higher order Poincare sphere for 3D and possibly 4D Codes. The beams provided by the system described herein can be realized with a combination of optics, amplitude and phase control for communications, sensing and directed energy. Quantum communication and sensing can be improved by using the beams and beam control provided by this system.

Numeric representations of the system described herein is provided below. The near-field output from the system represented by Eq. (8) can be rewritten as separable functions with respect to only ρ or ϕ terms,

$${U}_{n e a r} ( ρ , θ ) = P ( ρ ) Φ ( ϕ ) . \qquad ( 12 )$$

$$P ( ρ ) = exp ( - \frac{{( ρ - {p}_{0} )}^{2}}{{w}_{ring}} ) , \qquad ( 13 )$$

$$Φ ( ϕ ) = exp [ - \frac{{ϕ}^{2}}{{( β π )}^{2}} ] exp ( im ϕ ) . \qquad ( 14 )$$

Since the far field light distribution is the Fourier transform of the near field, then

$${U}_{far} ( r , θ ) = \frac{1}{i {λ}_{0} F} ℱ \{ {U}_{near} ( ρ , ϕ ) \} = \frac{1}{i {λ}_{0} F} ℱ \{ exp ( - \frac{{ρ}^{2}}{{w}_{ring}^{2}} ) \} \cdot ℱ \{ δ ( ρ - {ρ}_{0} ) exp [ - \frac{{ϕ}^{2}}{{( β π )}^{2}} ] exp ( im ϕ ) \} . \qquad ( 15 )$$

As shown in Eq. (15), there are two Fourier transforms that can be solved. Starting with the definition of the polar coordinate Fourier transform,

$${U}_{far} ( r , θ ) = \frac{1}{i {λ}_{0} F} {\int }_{- π}^{π} {\int }_{0}^{∞} {U}_{near} ( ρ , ϕ ) exp ( - i \frac{2 π}{{λ}_{m} F} ρ r cos ( θ - ϕ ) ) ρ d ρ d ϕ , \qquad ( 16 )$$

the term [symbol] of in Eq. (15) can be written as,

$$F \{ δ ( ρ - {ρ}_{0} ) exp \{ - \frac{{ϕ}^{2}}{{( β π )}^{2}} \} exp ( im ϕ ) \} = {\int }_{- π}^{π} {\int }_{0}^{∞} δ ( ρ - {ρ}_{0} ) exp [ - \frac{{ϕ}^{2}}{{( β π )}^{2}} ] exp ( im ϕ ) exp ( - i \frac{2 π}{{λ}_{m} F} ρ r cos ( θ - ϕ ) ρ d ρ d ϕ ) . \qquad ( 17 )$$

Eq. 17 can be expanded into

$$exp ( - i \frac{2 π}{{λ}_{m} F} ρ r cos ( θ - ϕ ) ) = {\sum }_{n = - ∞}^{+ ∞} {( - 1 )}^{n} {J}_{n} ( \frac{2 π}{{λ}_{m} F} ρ r ) exp [ in ( θ - ϕ ) ] . \qquad ( 18 )$$

which allows for Eq. 17 to be rewritten as

$$F \{ δ ( ρ - {ρ}_{0} ) exp \{ - \frac{{ϕ}^{2}}{{( β π )}^{2}} \} exp ( im ϕ ) \} = {\sum }_{n = - ∞}^{+ ∞} {( - i )}^{n} exp ( in ( θ ) ) {\int }_{0}^{∞} δ ( ρ - {ρ}_{0} ) {J}_{l} ( \frac{2 π}{{λ}_{m} F} ρ r ) ρ d ρ {\int }_{- π}^{π} exp [ - \frac{{ϕ}^{2}}{{( β π )}^{2}} + i ϕ ( m - n ) ] d ϕ . \qquad ( 19 )$$

The azimuthal integral can be solved by

$${\int }_{- π}^{π} exp [ - \frac{{ϕ}^{2}}{{( β π )}^{2}} + i ϕ ( m - n ) ] d ϕ = \frac{- i βπ \sqrt{π}}{2} exp ( - \frac{{( β π )}^{2} {( m - n )}^{2}}{4} ) ( erfi ( \frac{i}{β} + \frac{β π ( m - n )}{2} ) - erfi ( - \frac{i}{β} + \frac{β π ( m - n )}{2} ) ] = βπ \sqrt{π} exp ( - \frac{{( β π )}^{2} {( m - n )}^{2}}{4} ) Im [ erfi ( \frac{i}{β} + \frac{β π ( m - n )}{2} ) ] . \qquad ( 20 )$$

The far field light distribution in Eq. (15) reduces to the final analytic terms as given by Eq. (9), in which the Bn term is the weighting term and shifts power between different Bessel terms. Considering the α=0 case, given n=m+k=l+k, k=0, 1, 2 . . .

$${B}_{n = l + k} = {( - i )}^{l + k - 1} 2 exp ( - \frac{{( β π )}^{2} {( l - ( l + k ) )}^{2}}{4} ) Im [ erfi ( \frac{i}{β} + \frac{β π ( l - ( l + k ) )}{2} ) ] = {( - i )}^{l + k - 1} 2 exp ( - \frac{{( k βπ )}^{2}}{4} ) \cdot Im ( erfi ( \frac{i}{β} - \frac{k βπ}{2} ) ) . \qquad ( 21 )$$

When using the case where n=m−k=l−k,

$${B}_{n = l - k} = {( - i )}^{l - k - 1} 2 exp ( - \frac{l - {( l - k )}^{2} {( β π )}^{2}}{4} ) Im [ erfi ( \frac{i}{β} + \frac{( l - ( l - k ) β π )}{2} ) ] = {( - i )}^{l - k - 1} 2 exp ( - \frac{{( k βπ )}^{2}}{4} ) \cdot Im ( erfi ( \frac{i}{β} + \frac{k βπ}{2} ) ) . \qquad ( 22 )$$

Since the imaginary error function is an odd function, we have

$${B}_{n = l - k} = {( - i )}^{l - k - 1} 2 exp ( - \frac{{( k βπ )}^{2}}{4} ) \cdot Im [ erfi ( \frac{i}{β} + \frac{k βπ}{2} ) ] = \frac{{( - i )}^{l + k - 1}}{{( - i )}^{2 k}} 2 exp ( - \frac{{( k βπ )}^{2}}{4} ) \cdot Im ( - erfi ( - \frac{i}{β} - \frac{k βπ}{2} ) ) = {( - 1 )}^{k} {( - i )}^{l + k - 1} 2 exp ( - \frac{{( k βπ )}^{2}}{4} ) \cdot Im ( - erfi ( - \frac{i}{β} - \frac{k βπ}{2} ) ) = {( - 1 )}^{k} {( - i )}^{l + k - 1} 2 exp ( - \frac{{( k βπ )}^{2}}{4} ) \cdot Im ( - erfi ( \overline{\frac{ι}{β} - \frac{k βπ}{2}} ) = {( - 1 )}^{k} {( - i )}^{l + k - 1} 2 exp ( - \frac{{( k βπ )}^{2}}{4} ) \cdot Im ( \overline{- erfi ( \frac{ι}{β} - \frac{k βπ}{2} )} ) = {( - 1 )}^{k} {B}_{n = l + k} . \qquad ( 23 )$$

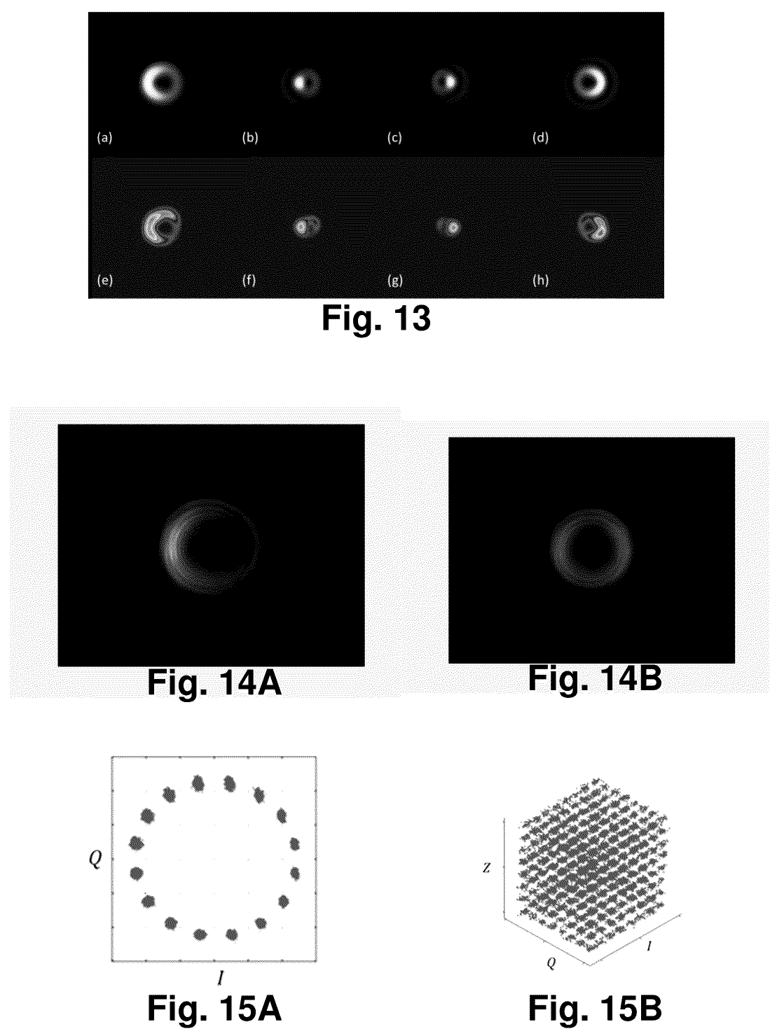

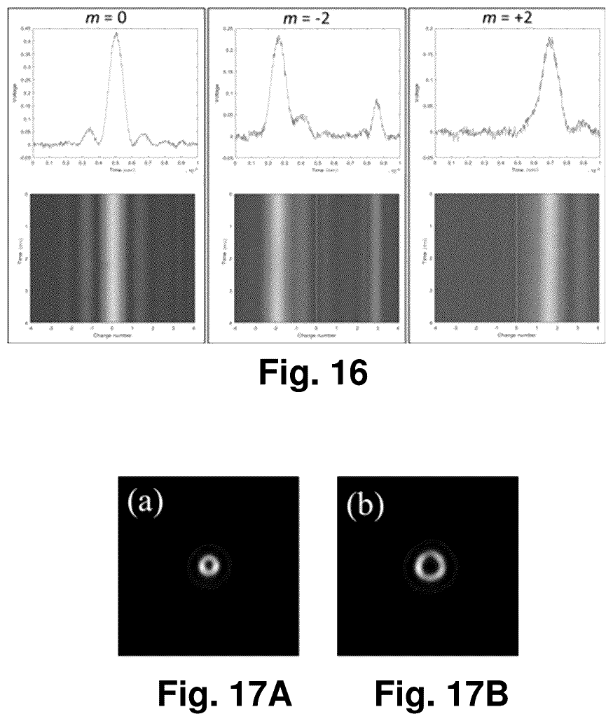

Referring to FIGS. 16a and 16b, this system can be a receiver as well as a transmitter. This system can also be used in reverse so that the system provides a sensor to detect beams with OAM. Instead of generating specific OAM modes corresponding to the RF driving frequency, the AOD can scan through the frequency range to detect the OAM charge number of incoming beams. In the embodiment, the input beam 40 can enter a first telescope 42 and be directed into the log polar optics 20. The beam can enter into a second telescope 44 and be directed into the AOD 14. A fiber detector 46 then receives the beam.

Referring to FIG. 16b, individual beams with OAM modes of m=0 (left), m=−2 (middle) and m=+2 (right) were examined using the system. The top row of FIG. 16b, indicates a single scan in time of frequencies applied to the AOD that correspond to a scan of OAM modes of m=−4 to m=+4. Because of the speed of the AOD, the change in the OAM mode can be monitored in time as shown in the bottom row of figures, resulting in a dynamic OAM mode sorter.

The acousto-optic deflector can include crystals that can be used as Q-switch modulators in solid state lasers. Since these are used intracavity, they have a large optical power handling capacity and have typical damage thresholds on the order of MW/cm². The switching speed of the present system can be determined by the acoustic wave velocity in the AOD and the input beam size. The switching speed of the current system has been demonstrated to be on the order of 400 kHz, which is much faster than traditional DMD/SLM systems.

Referring to FIGS. 15A and 15B, the AOD can be driven with a single frequency or multiple frequencies. Multiple frequencies that generate charges +m and −m can be applied to the AOD simultaneously to create coherently combined OAM modes. The deflection of both charge +m and −m can be 1^{st} order deflections with slightly different deflection angles. Information can be encoded onto both the amplitude and relative phase of the coherently coupled OAM modes and mapped to a three-dimensional constellation space. The 3D quadrature amplitude modulation (QAM) constellation can be based on a higher-order Poincare sphere equivalent for OAM states. In one example of the system, a 532 nm laser can be used with two coherent OAM charges of m=±2 are generated after passing through the system by applying frequencies f+2≈124.28 MHz and f−2≈125.72 MHz simultaneously to the AOD. Two different modulation schemes can be applied to the acoustic cell to control the output beam. A 16-PSK signal and a 512-QAM signal with the modulation rate of 200 kHz are shown in FIGS. 15a and 15b. This system can have advantages directed to improving the spectral efficiency of a communications link. This system can improve upon and advantage to encoding schemes and multiplexing techniques in both free-space and optical fiber-based communication links. Optical beams can be used as a data carrier for both free-space and underwater communications.

The system can be adapted to operate at about a 450 nm wavelength so that the diode amplitude can be controlled by an external signal. The AOD can be used to produce multiple interfering OAM beams simultaneously. Due to the traveling wave in the AOD, different OAM beams can have a small shift in the optical frequency, producing a continuously changing interference pattern due to the continuous change in phase of the sinusoidal waves on the AOD. The diode amplitude can be pulsed as a method of sampling the output beam similar to a strobe light. If the pulse width is on the order of the rate of change of the interference pattern, and repeats periodically, in synchronization with the signal applied to the AOD, the beam profile can be sampled and temporally controlled.

In one example of the system in operation, the laser source is a ThorLabs LP450-SF15 single-mode fiber-pigtailed diode placed in a ThorLabs LDM9LP pigtailed driver mount. The output is then polarized vertically and resized to approximately 3 mm in diameter where it is passed through the AOD. The output of the AOD is then shaped into a line approximately 3 mm by 0.3 mm using a soft aperture. The line is then passed through the log-polar optical transformation system after which a 400 mm lens is used to image the far field beam profile onto a Spiricon SP300 CCD camera with an integration time of 10 ms and a frame rate of 30 Hz. The voltage signals applied to the AOD is V=sin (2πf₁t)+sin (2πf₂t+θ) to generate two different structures as shown in FIGS. 17A and 17B. The first signal has frequencies f1=95.4 MHz and f2=84.6 MHz to create a beam with m=±1 and the second signal has f1=100.9 MHz and f2=79.1 MHZ to create a beam with m=±2 for a beat frequency of 10.9 MHz and 21.8 MHz respectfully. This rotation far exceeds the framerate of the CCD array and therefore the average image is collected and appears as a ring. FIGS. 17A and 17B illustrate the time-averaged signal of the system output for a two-beam combination of m=±1 and m =±2.

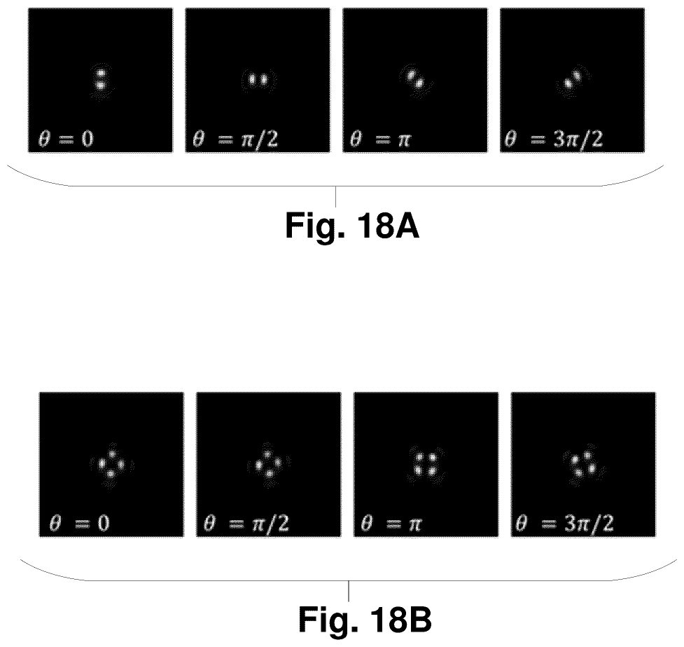

In one example, a 20 ns Gaussian pulse was applied to the diode at a repetition rate of 3 MHz which can be greater than the switching speed of the AOD; limited by the velocity of the acoustic wave and the beam diameter. The voltage signal applied to the AOD can have the same repetition rate. The CCD array can integrate with approximately 30,000 pulses per frame, timed so that the pulse is synced with the signal applied to the AOD. This pulse can be coupled with a DC bias current using a bias-tee located inside a laser diode mount. The DC bias applied to the laser diode can be set to about 30 mA and/or a level just above the threshold. In conjunction with the pulse and the losses in the optical system, the output pulse incident on the CCD array can have a peak power of 17 mW. In addition, the relative phase between the two signals θ can be adjusted to rotate the interference fringes. These profiles are shown in FIGS. 18A and 18B. for four different phase levels. Due to the continuous rotation, the pulse and the AOD signal must be properly aligned to sample the proper beam combination. FIGS. 18A and 18B illustrate a time-averaged signal of the system output with a 20 ns Gaussian amplitude pulse for a two-beam combination of FIG. 18A m=±1 and FIG. 18b m=±2. These images show the expected interference pattern, where the number of fringes is equal to the difference in charge number. In addition, the apparent rotation angle is proportional to this difference as can be seen. In one embodiment, the full width at half-maximum (FWHM) of the pulse is approximately 12% of the rotation rate for the first case and approximately 26% for the second. This difference is due to the required frequencies listed above, causing a faster rotation rate for the larger beams. This indicates that there will still be some blurring of the beam over the pulse which could impact sensing systems.

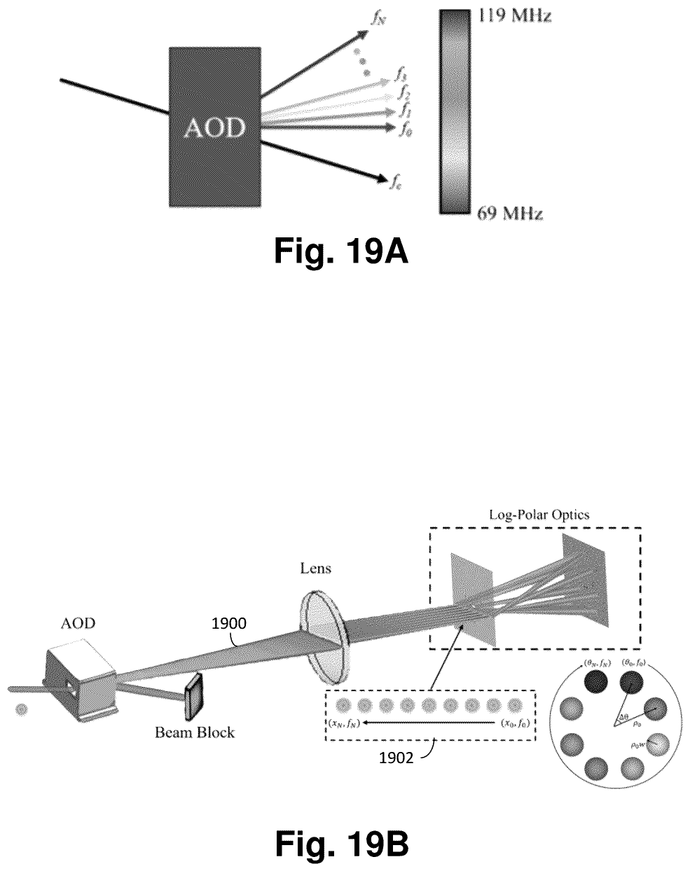

In one embodiment the system is used for implementing UC-FDA in the optical domain for the generation of higher order Bessel-Gaussian beams, a modified HOBBIT system is provided. This optical system is shown conceptually in FIGS. 19A and 19B. FIG. 19A shows the frequency shift associated with related diffraction angles and FIG. 19B shows the system architecture includes an AOD, Fourier lens, and log-polar coordinate transform optics. Beams 1900 are the optical frequency fc and not the AOD frequency. The field amplitude 1902 is shown for each step beneath the system.

There are two components to this system: an acousto-optic deflector (AOD) which deflects an input beam, and a pair of log-polar optics that geometrically map points on a line to a ring. The first order Bragg diffraction from a sinusoidal signal on an AOD follows the relation:

$$θ \approx \frac{λ}{V} f \qquad ( 24 )$$

where θ is the diffraction angle, A is the optical wavelength, V is the acoustic velocity, and f is the acoustic frequency. This idea is visually shown in FIG. 19A where a beamlet array can be generated with different colors indicating the unique frequency tagging (f₀, f₁, f₂, f₃, . . . f_{N}) of each beamlet created in the AOD. The beam deflected to the first order has an applied Doppler shift equal to ƒ. This fact is used to generate a linear FDA by superposing many of these sinusoids with different acoustic frequencies as seen in FIG. 19B which follows

$$S ( t ) = {\sum }_{0}^{N - 1} {S}_{n} ( t ) sin ( 2 π {f}_{n} t + {ϕ}_{n} ( t ) ) \qquad ( 25 )$$

where N is the number of beamlets, and the nth beamlet has an amplitude of sn(t), a frequency shift of ƒn, and a phase of φn(t). Since the power in the signal must be normalized, the total power in the AOD signal can be written as

$$Γ = \frac{2}{T} {\int }_{0}^{T} {\vert \frac{s ( t )}{max ( s ( t ) )} \vert}^{2} dt \qquad ( 26 )$$

where T is the time duration of the signal. For a sum of equivalent sine waves with different frequencies, the efficiency goes as 1/N. In one embodiment the AOD's efficiency does not change over the used bandwidth which can be accomplished through scaling sn(t) according to the measured efficiency. After the AOD, the beamlets with different frequencies and tilts are Fourier transformed onto the first log-polar optic that then applies the coordinate mapping (u,v)→(r,θ) where θ=v/A, r=Be−u/A, and A and B are design parameters for the log-polar optics. Before the coordinate mapping, the linear array of Gaussian beamlets can be expressed by

$${\vec{E}}_{line} = {\sum }_{n = 0}^{N - 1} {S}_{n} ( t ) exp ( - \frac{{( x - {x}_{n} )}^{2} + {( y - {y}_{0} )}^{2}}{{σ}^{2}} ) exp ( - j 2 π ( {f}_{c} - {f}_{n} ) t + {φ}_{n} ( t ) ) \hat{y} \qquad ( 27 )$$

where

$$σ = \frac{λ {F}_{1}}{π {w}_{1}} ,$$

w₁ is the radius of us initial Gaussian beam, F₁ is the focal length of the lens that takes the Fourier transform of the AOD plane, and x and y are the coordinate variables in the horizontal and vertical directions, respectively. The equation is summed over xₙ which corresponds to the linear horizontal shift of each beamlet, y₀ is a vertical shift of the linear array on the log-polar optics, and fc is the frequency of the light propagating into the AOD.

After the geometric transform, the result is a circular array of frequency-shifted beamlets which can be described in the near field by

$$\vec{{E}_{near} ( ρ , θ , t )} = {\sum }_{n = 0}^{N - 1} {S}_{n} ( t ) = exp ( - \frac{{( ρ - {ρ}_{0} )}^{2}}{{ρ}_{0}^{2} {w}^{2}} - \frac{{( θ - {θ}_{n} )}^{2}}{{w}^{2}} - j ( 2 π ( {f}_{c} + {f}_{n} ) t + {φ}_{n} ( t ) ) ) \hat{y} \qquad ( 28 )$$

where

$${ρ}_{0} = B exp ( - \frac{{y}_{0}}{A} ) = 1.365$$

mm is the radius of the circular array, w=σ/A is the 1/e² angular beam width of the individual Gaussian beamlets, fc is the frequency of the light propagating into the AOD, ƒₙ and θₙ are the frequency and azimuthal location of the n^{th} beamlet, respectively. Note here that the phase is given as a piston phase, φₙ, per spot and does not relate to the coordinate variables. We define the azimuth so that the AOD minimum frequency ƒ₀ places a beam at θ=0, so that for N beamlets generated by evenly spaced frequencies, the azimuthal position of the nth beamlet, using Eq. (24), is given by

$${θ}_{n} = n Δθ = n Δ f \frac{λ {F}_{1}}{AV} \qquad ( 29 )$$

where Δf is the difference between consecutive frequencies, and Δθ is the difference between consecutive azimuthal positions. F₁ is the focal length of the lens that takes the Fourier transform of the AOD plane, A is a log-polar parameters, and V is the acoustic velocity of the AOD. This leads to the linear relationship between the applied AOD frequency, and the azimuthal position of the beamlets

$$Δθ = Δ f \frac{λ {F}_{1}}{AV} \qquad ( 30 )$$

Considering only the phase due to frequency diversity and uniform amplitude, that is, φₙ(t)=0 and sₙ(t)=1, the resultant phase accumulated in time azimuthally about the beamlet array is given by

$$arg ( {E}_{near} ) = 2 π ( {f}_{c} + {f}_{0} ) t + 2 π \frac{Δ f}{Δθ} t {θ}_{n} \qquad ( 31 )$$

where only the second term affects the OAM gradient around the azimuth. Therefore, over each period, P=1/Δf, the near-field beam carries a time-varying, approximate OAM value of

$$m ( t ) = \{ \begin{matrix}2 π \frac{Δ f}{Δθ} t & t \leq \frac{P}{2} \\ 2 π \frac{Δ f}{Δθ} t - N & t \geq \frac{P}{2}\end{matrix} \qquad ( 32 )$$

In one embodiment, m(t) cannot exceed the Nyquist sampling rate of beamlets around the ring, giving a maximum OAM of |m_max|=N/2, and the rate of OAM shifting is given by the derivative dm/dt=2πΔf/Δθ. Therefore, to a first approximation, the near field expression for a circular array of beamlets with constant amplitude and no asymmetry can be written as

$$\vec{{E}_{near}} ( ρ , θ , t ) \sim exp ( - \frac{{( ρ - {ρ}_{0} )}^{2}}{{ρ}_{0}^{2} {w}^{2}} - j 2 π ( {f}_{c} - {f}_{0} ) t ) exp ( - jm ( t ) θ ) \hat{y} \qquad ( 33 )$$

and the far-field expression can be approximated for integer OAM modes as

$$\vec{{E}_{far}} ( r , ϕ , z , t ) \sim exp ( - \frac{{r}^{2}}{{w}_{G}^{2}} ) {j}_{m ( t )} ( k , r ) exp [ j ( 2 π {f}_{c} t + {k}_{z} Z - m ( t ) ϕ ) ] \hat{y} \qquad ( 34 )$$

where Jₘ(t) is the Bessel function of the first kind with time dependent order, ρ and ϕ are the far field coordinate variables, W_{G} is the Gaussian waist of the Bessel beam, k_{z} and kᵣ are the longitudinal and radial wave numbers, respectively. Also, this approximation has been shown to increase in accuracy with larger N·1

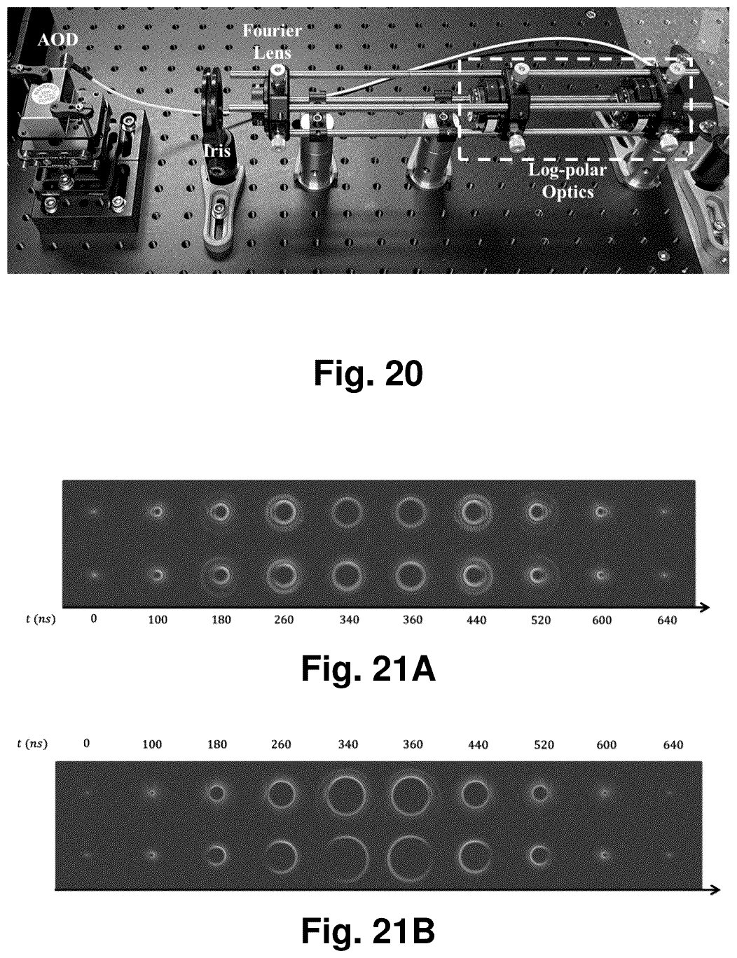

In one embodiment, the system can be of a design that has few components and is shown in FIG. 20. Because of the time-dependent OAM scanning that can be a result of the frequency diversity, a pulsed laser source can be utilized to be able to capture the individual modes. This was possible due to the pulse's short duration and interaction time with the AOD compared to the time-varying OAM, causing the acoustic traveling wave in the AOD to appears frozen. This can be written in the form of an explicit relation

$${t}_{p} + \frac{Ln}{c} ≪ {( \frac{dm}{dt} )}^{- 1}$$

where tₚ=150 fs is the pulse duration, L =14 mm is the thickness of the AOD crystal, n=2.3098 is its refractive index of TeO₂, c is the speed of light,

$${( \frac{dm}{dt} )}^{- 1} = 20$$

and ns is the time between integer OAM states. By using a delay generator, the time at which the optical pulse interacts with the AOD can be controlled, allowing the generation of the individual modes across the entire OAM scan. The laser source used for the system is a pulsed 517 nm laser (Light Conversion: CARBIDE CB3-80-0800-20-H) with a pulse duration of tₚ=150 fs. In operations, the light source for the input can have a wavelength of visible, near-infrared, short-wave infrared, mid-wave infrared, and long-wave infrared. In one embodiment, the light source can be visible light in the range of 380 to 700 nm. In one embodiment, the light source can be near-infrared in the range of 700 to 1,400 nm. In one embodiment, the light source can be short-wave infrared in the range of 1,400 nm to 3 μm. In one embodiment, the light source can be mid-wave infrared in the range of 3 μm to 8 μm. In one embodiment, the light source can be long-wave infrared in the range of 8 μm to 20 μm.

A 5× reducing telescope (not shown) can be used to reduce the incoming beam diameter from 4.3 mm to 2w₁=860 μm. This beam then propagated approximately 50 mm before it entered the TeO₂ AOD (Brimrose: TED10-100-50-532-AR) that was used to generate N simultaneous frequency-shifted beamlets. The AOD had a center frequency of 94 MHz and a bandwidth of 50 MHz. This bandwidth was divided by the number of desired beamlets, which resulted in a frequency step between beamlets of Δf=50 MHZ/N. The beamlets then propagated to a Fourier lens (F₁=150 mm) that was one focal length away from the AOD and one focal length away from the log-polar optics. The two log-polar coordinate transform optics work as a pair to perform the optical transformation of wrapping the linear array of beamlets into an annular distribution. The mapping process involves two customized diffractive phase optics. It is well known that there is an OAM dependent lateral shift of the beam on the second log-polar optic because of the transformation. This shift is given by

$$Δ x = \frac{λ {F}_{LP} m}{2 π A}$$

where λ is the wavelength of light, F_{LP}=102.9 mm is the focal length of the lens function on the first log-polar optic, m is the OAM charge number, and A=6 mm/2π is a log-polar design parameter. As the OAM charge number increases, this lateral shift will increase introducing aberrations to the generated modes which become worse for larger OAM charge numbers. This lateral shift on the log-polar optics can be seen in the far-field experimental data as a vertical shift when using 128 beamlets. After the log-polar optics, the output of the system is a circular array of beamlets, forming the uniform circular frequency diverse array. These beamlets can have a radius β₀w=325 μm and are equally spaced on a circular grid with radius of ρ₀=1.365 mm.

In operation the circular array from the optical system can be propagated through a lens (F₂=400 mm) to the Fourier plane. The simulation (top) and experimental (bottom) results are shown for a 32 beamlet array in FIG. 21A, and a 128 beamlet array in FIG. 21B, where on one embodiment the simulations were obtained by generating the near field ring using the log-polar optics and applying the Fresnel propagator to reach the far field. As shown, FIG. 21A has an azimuthal spacing of Δθ=32/2π, and a frequency difference of Δf=1.5625 MHz between beamlets, giving a period P=640 ns and the time between integer OAM states of

$${( \frac{dm}{dt} )}^{- 1} = 20$$

ns following Eq. (31).

FIGS. 21A and 21B show a simulation (FIG. 21A) and experimentally measured (FIG. 21B) far-field for a 32-beamlet array over the 640 ns period and 128-beamlet array over the 2.56 us period respectively.

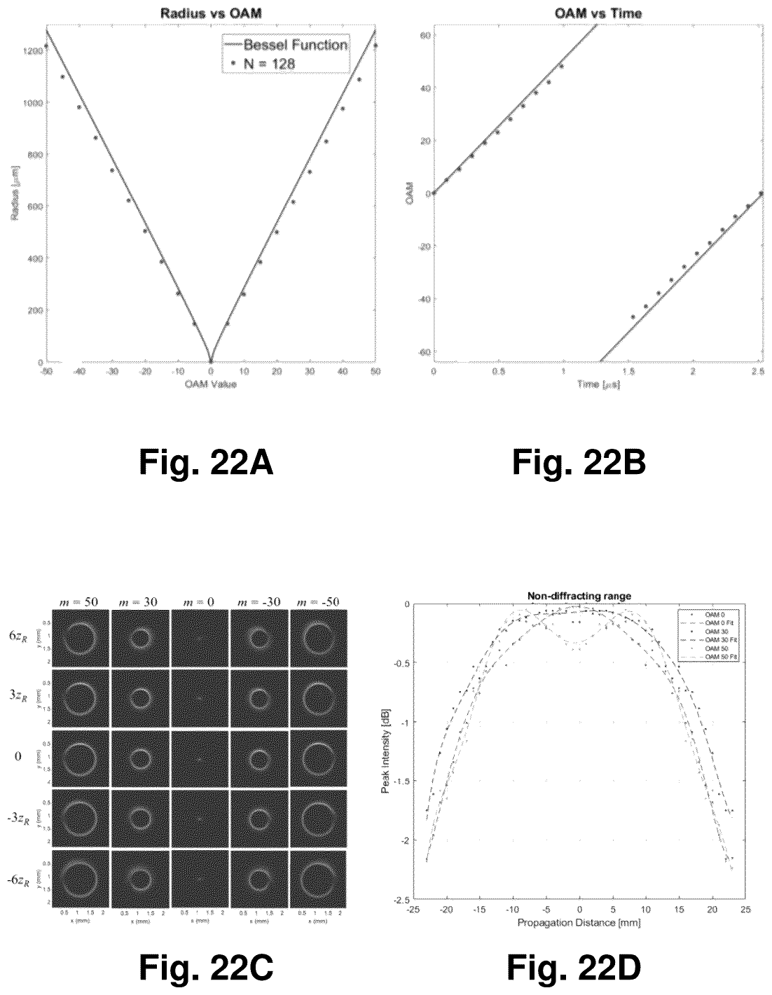

FIG. 21B shows an azimuthal spacing of Δθ=128/2π, and a frequency difference of Δf=390.6 kHz between beamlets, giving a period P=2.56 μs and an equivalent time difference between integer OAM states. These rapidly scanning OAM modes are a result of frequency diversity and match well with corresponding simulations and were validated for the 128 beamlet array in FIG. 21A by comparing the ring radius in the far-field to the maximum of the corresponding higher order Bessel function with

$${k}_{r} = \frac{{ρ}_{0}}{{F}_{2}} k ,$$

where ρ₀ is the ring radius given above and F₂=400 mm is the focal length of the lens taking the Fourier transform. The estimated OAM modes from FIG. 22A along with their relative time set on a delay generator were mapped onto the theoretical time scale obtained from taking the derivative of Eq. (31) with the system parameters that can be seen in FIG. 22B. For FIG. 22A, the OAM values, determined solely by radius, have a mean error of 6.39% which could be due to inaccuracies of the delay generator or optical power on the beam. This error carries over into FIG. 22B, where the experimentally measured OAM valued are plotted over time. Overall, for N=128 the topological charge closely follows the theoretical line generated by the higher order Bessel function as well as the predicted time evolution, validating Eq. (31) and the approximation used in Eq. (33). In addition, the efficiency measured at N=128 was 1.1%, which closely follows the predicted efficiency of 0.9% from Eq. (26).

FIG. 22C shows verification of OAM values for the 128 beamlet array over a range of ±50 as determined by the radius of the theoretical Bessel function with matching kᵣ. FIG. 22D shows OAM values obtained from the results of FIG. 22C along with their corresponding delay generator offset plotted against the theoretical curve for OAM vs time.

In operation, the individual Gaussian spots are small enough that they, once transformed into a ring, form a PV, which corresponds to a narrow spatial frequency. This leads to non-diffracting beam structures in the far-field. For a Bessel Gaussian beam, the maximum distance for non-diffracting behavior is given by

$$Δ z = \frac{{W}_{G}}{D} \qquad ( 35 )$$

where W_{G} is the Gaussian waist of the Bessel beam and D is the divergence angle. This can be related back to the Gaussian ring width (w) of the perfect vortex by the relation

$${W}_{G} = \frac{λ {F}_{2}}{π w}$$

where F₂ is the focal length of the Fourier lens. D is then given by the cone angle of the Bessel beam

$$D = arcsin ( \frac{λ {k}_{r}}{2 π} ) .$$

Because of amplitude modulation that resulted from the log-polar mapping, the ring width, w, is different for the x dimension and the y dimension. As a result, Δz was calculated in the x dimension and the y dimension to bound the maximum distance for the non-diffracting behavior. The average Δz was calculated to be 40 mm. To experimentally confirm the non-diffracting nature of these beams, the transverse intensity distributions were measured out to +/−6 Z_{R} from the Fourier plane, where Z_{R} is the Rayleigh range of a Gaussian beam with the same radius as the 0th order Bessel-Gaussian beam center lobe. The results for a 128 beamlet array are qualitatively shown in FIG. 22A for topological charge m=50, 30, 0, −30, 50. For the case of measuring the non-diffracting range, a Fourier lens F₂=200 mm was used. Each column of FIG. 22A is normalized to the zero position which is the Fourier plane. The 0th order Bessel Gaussian beam had a center lobe radius of 25 μm. A Gaussian beam of this radius would have a Rayleigh range of Z_{R}=3.8 mm. It can be seen from FIG. 22A that the intensity distribution changes very little as the beam propagates a total distance of 12Z_{R}, or 45.6 mm, indicating that these beams are indeed non-diffracting farther than a comparable Gaussian beam. Furthermore, FIG. 22B shows that the measured peak intensity for topological charges 0, 30, and 50 only fall off by a little more than 2 dB over the 46 mm region. The trend in peak power is traced in FIG. 22B using a polynomial fit. The peak intensity follows a Gaussian envelope over the depth of focus where oscillations in the peak power appear nearer to the focal plane. FIG. 22A are images of several OAM modes propagation through +/−6 zR or 45.6 mm. FIG. 22B shows a peak intensity measured for topological charges 0, 30, and 50. The dashed lines are polynomial fits for the different topological charges.

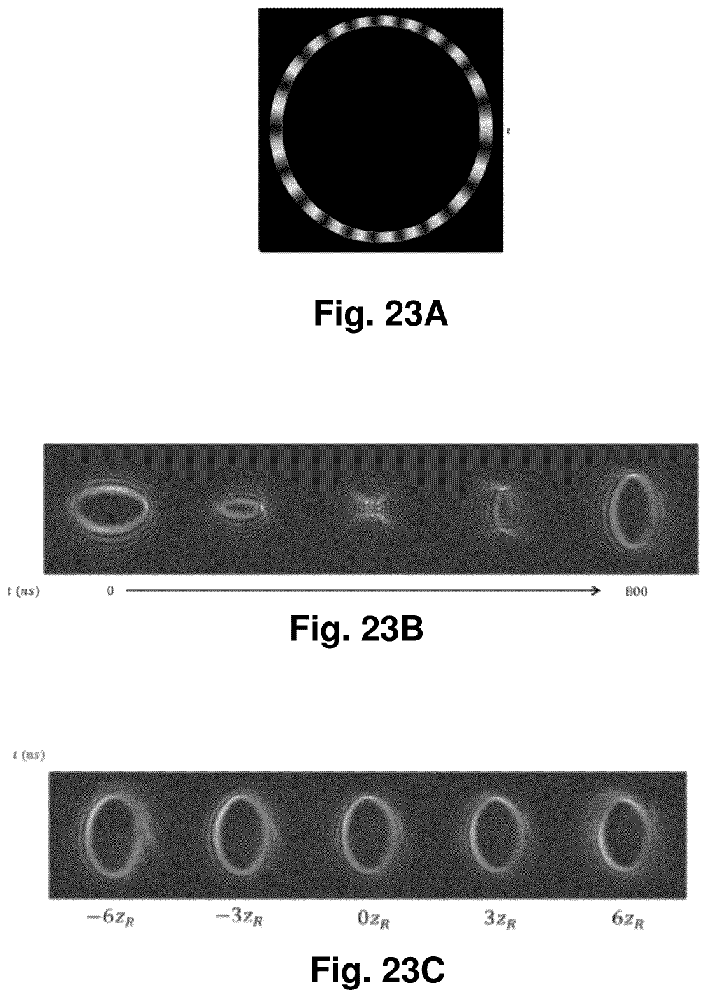

The structure of this system is not limited to Bessel-Gaussian modes, as highlighted in Eq. (27), where the initial phase, φₙ, can be independently set for each beamlet at t=0. Using 128 beamlets, FIGS. 23A through 23C show experimental results for a novel structure like an ellipse. FIG. 23A shows the generation of an ellipse using uniform amplitude, sₙ(t)=1, and the phase function

$${φ}_{n} = {αsin}^{2} ( \frac{2 π n}{128} ) \qquad ( 36 )$$

where α=2π is the amplitude of the phase function which controls the ellipticity of the beam. The phase function for the elliptical beam is shown FIG. 23A, followed by the experimentally measured elliptical structure over an 800 ns time frame in FIG. 23B. This demonstrates that arbitrary temporally dependent, non-diffracting structures can be generated. It's worth noting that even with the independent phase control with this generation method, the frequency diversity still allows for the rapid evolution of the generated modes in time. As with the previously demonstrated modes, the elliptical beam still has a long depth of focus. This is shown in FIG. 23C where the intensity profile is captured with the distance labeled in multiples of Z_{R} with very little change. FIGS. 23A through 23C show the generation of arbitrary non-diffracting amplitude structure using the phase control of the individual beamlets in the array to generate an ellipse. FIG. 23A shows a phase structure for the initial ellipse at t=0. FIG. 23B shows the experimental frequency diverse evolution of the elliptical structure within 800 ns. FIG. 23C shows of do focus measurements for the ellipse at 1000 ns.

In one embodiment the system can use pulsed source to visualize the individual modes. In one embodiment, a continuous wave source ca be used adapted to provide the radio frequency regime to use rapid, continual mode scanning for imaging, ranging, and communications applications. In one embodiment, the output from the system can be used as a seed for a power amplifier to address the efficiency using a large number of beamlets. In one embodiment, the system can include aberration correction for the lateral shift on the log-polar optics for higher charge numbers, and wavelet formulation exploiting the properties of the frequency diverse array to improve the system efficiency over the existing technology.

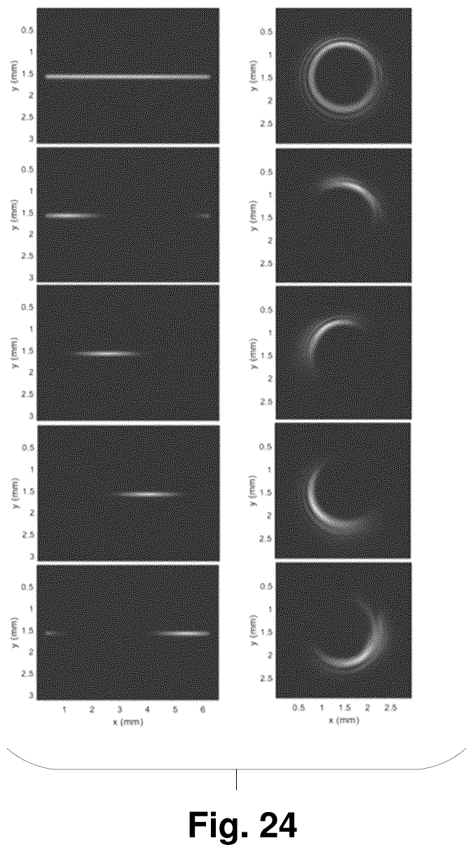

In one embodiment, the system can include amplitude control, phase control or both. By adjusting the amplitude and phase of the individual beamlets, the system can generate customized non-diffracting output modes. The phase control is shown in FIG. 23 and the amplitude control is demonstrated in FIG. 24. In this application, the amplitude is the intensity or brightness of the light source. The system allows this to be varied for different applications.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A tunable orbital angular momentum system comprising:
an acousto-optic deflector adapted to receive an input beam deflected along an optical axis when a voltage is applied to the acousto-optic deflector and to produce a beamlet array;
a lens adapted to receive the input beam and transmit the input beam to a pair of log polar options; and,
the pair of log-polar optics adapted to provide an optical transformation of wrapping the beamlet array into an annular distribution.

2. The system of claim 1 wherein each beam in the beamlet array has a unique frequency.

3. The system of claim 1 wherein each beam in the beamlet array has a unique tilt.

4. The system of claim 1 wherein the beamlet array undergoes a Fourier transformed to provide a geometric transformation and provide a circular array of frequency-shifted beamlets.

5. The system of claim 1 wherein the input beam is generated using a pulsed laser source.

6. The system of claim 5 wherein the pulsed laser source has a short duration and provides for an acoustic traveling wave to appear frozen.

7. The system of claim 5 wherein a time when an optical pulse interacts with the acousto-optic deflector is controlled to provide for generation of a set of individual modes across the orbital angular momentum scan.

8. The system of claim 5 wherein the pulsed laser source has a pulse duration in the range of 100 fs to 1 ps.

9. The system of claim 1 wherein the input beam is generated using a continuous wave laser source.

10. The system of claim 1 wherein the input beam can have a wavelength taken from the group consisting of visible light, near-infrared, short-wave infrared, mid-wave infrared, and long-wave infrared.

11. The system of claim 1 wherein the input beam is reduced using a reducing telescope.

12. The system of claim 1 wherein the lens is disposed one focal length away from the acousto-optic deflector and one focal length away from the log-polar optics.

13. The system of claim 1 wherein the lens is a Fourier lens.

14. The system of claim 1 including an acousto-optic deflector output that includes a circular array of beamlets forming the uniform circular frequency diverse array.

15. The system of claim 14 wherein the circular array of beamlets are equally spaced on a circular grid.

16. The system of claim 1 wherein the system include an amplitude control, and a phase control adapted to vary the amplitude and phase of the beamlets in the beamlet array to provide a customized non-diffracting output mode.

17. A tunable orbital angular momentum system comprising:
an acousto-optic deflector adapted to receive an input beam deflected along an optical axis when a voltage is applied to the acousto-optic deflector, produce a beamlet array having a set of beamlets and uniquely frequency shift each beamlet in the beamlet array to provide frequency diversity;
a lens adapted to receive the input beam and transmit the input beam to a pair of log-polar optics; and,
the pair of log-polar optics is adapted to provide an optical transformation of wrapping the beamlet array into an annular distribution.

18. The system of claim 17 wherein the lens is adapted to perform a geometric transform of an acousto-optic deflector plane.

19. The system of claim 18 including a circular array of frequency-shifted beamlets created after a geometric transformation.

20. The system of claim 17 including a pulsed laser source to provide a beam into the acousto-optic deflector.

21. The system of claim 17 including a continuous wave laser source to provide a beam into the acousto-optic deflector.

22. A tunable orbital angular momentum system comprising:
an acousto-optic deflector adapted to receive an input beam from a pulse laser deflected along an optical axis when a voltage is applied to the acousto-optic deflector, produce a beamlet array having a set of beamlets and uniquely frequency shift each beamlet in the beamlet array to provide frequency diversity;
a lens adapted to perform a geometric transformation on the input beam and transmit the input beam to a pair of log-polar optics; and,
the pair of log-polar optics is adapted to provide an optical transformation of wrapping the beamlet array into an annular distribution.

23. The system of claim 22 wherein the acousto-optic deflector is adapted to provide time dependent scanning.

24. The system of claim 22 wherein the system include an amplitude control adapted to vary the amplitude of the beamlets in the beamlet array.

25. The system of claim 22 wherein the system include a phase control adapted to vary the phase of the beamlets in the beamlet array.
